(19) United States
(12) Patent Application Publication
(10) Pub. No.: US 2011/0005617 A1
(43) Pub. Date: Jan. 13, 2011

(54) VALVE CONFIGURATION FOR A LUBRICATION CIRCUIT OF A LATCHED PUMP APPLIED CLUTCH TRANSMISSION

(75) Inventors: James M. Hart, Belleville, MI (US); Clinton E. Carey, Monroe, MI (US); Paul D. Stevenson, Ann Arbor, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/885,606

(22) Filed: Sep. 20, 2010

Related U.S. Application Data
(62) Division of application No. 11/627,998, filed on Jan. 29, 2007.

(51) Int. Cl. F16K 21/04

(52) U.S. Cl. 137/511

(57) ABSTRACT

A hydraulic control circuit for a transmission is provided including a source of pressurized fluid and at least one selectively engageable torque transmitting mechanism. At least one latching valve is provided in communication with the source and is operable to selectively communicate the pressurized fluid to effect engagement of the at least one torque transmitting mechanism. The at least one latching valve is operable to maintain engagement the at least one torque transmitting mechanism irrespective of the presence of the pressurized fluid. A valve is in fluid communication with the source. A lubrication circuit is provided and is operable to lubricate the transmission. The valve is operable to variably communicate the pressurized fluid to the lubrication circuit. A transmission incorporating the hydraulic control circuit is also disclosed.

### CROSS-REFERENCE TO RELATED APPLICATION(S)

This application is a divisional application of U.S. patent application Ser. No. 11/627,998 filed Jan. 29, 2007.

### TECHNICAL FIELD

The present invention relates to vehicular transmissions and more specifically to a valve configuration for a lubrication circuit of a latched pump applied clutch transmission.

### BACKGROUND

In a typical automatic transmission, the amount of torque transmitted through the transmission is proportional to the holding torque of clutches or torque transmitting mechanisms. These torque transmitting mechanisms are typically fluid activated; therefore, the holding torque of the torque transmitting mechanisms is proportional to line pressure developed by a hydraulic pump. As a result, heat generated by bearings, bushings, torque transmitting mechanisms, and gear sets is also proportional to line pressure. Once the torque transmitting mechanisms are filled with fluid and stroked into engagement, and the leakage within the torque transmitting mechanism circuits is satisfied, the remaining fluid flow from the hydraulic pump can be dedicated to lubrication of components within the transmission. Pressurized fluid for lubrication is derived from a cooler feed circuit which originates at a line or main pressure regulator valve. The lubrication circuit of a typical transmission operates passively by flowing surplus pressurized fluid from the hydraulic pump through a fixed orifice.

In an automatic transmission having a latched-pump applied clutch (LPAC) system, a controllable pump pressure is used to apply torque transmitting mechanisms to effect gear shifting. Once an LPAC clutch is engaged, a latching valve is closed, thereby trapping hydraulic pressure within the hydraulic apply circuit of the torque transmitting mechanism, typically a plate-type clutch pack. Since the torque transmitting mechanism hydraulic circuit is sealed from the pump pressure circuit, by means of the latching valve, the line pressure can be lowered to minimize transmission spin losses. The engagement of the torque transmitting mechanism will be maintained irrespective of the line pressure by virtue of the latching valve.

In contrast to typical automatic transmissions, LPAC-equipped automatic transmissions do not need to supply pressurized fluid to the torque transmitting mechanism after latching has occurred. This functionality allows line pressure to be reduced while lubrication demand remains high. It is generally desirable to reduce line pressure in order to reduce spin loss and improve the efficiency of the transmission. However, reducing line pressure without increasing the flow of pressurized fluid to the lubrication circuit could prove to be fatal to bushings, bearings, and gear sets within the transmission, since lubrication fluid demand remains high during conditions of high torque transfer.

### SUMMARY

A transmission is provided having a source of pressurized fluid and a valve in fluid communication with the source and having a first position and a second position. A lubrication circuit is operable to lubricate the transmission. A valve is operable to communicate the pressurized fluid to the lubrication circuit. First and second orifices are disposed between the valve and the lubrication circuit. The valve is configured to supply the lubrication circuit with the pressurized fluid through each of the first and the second orifices when the valve is in one of the first position and the second position. Additionally, the valve is configured to supply the lubrication circuit with the pressurized fluid through the second orifice when the valve is in the other of the first position and the second position. Furthermore, the valve is a snap action valve that includes a differential area in fluid communication with the source. The differential area is operable to move the valve from the first position to the second position when the pressure of the pressurized fluid is greater than or equal to a predetermined value.

In an alternate embodiment, a transmission is provided having a source of pressurized fluid and at least one selectively engageable torque transmitting mechanism. At least one latching valve is provided in communication with the source and operable to selectively communicate the pressurized fluid to effect engagement of the at least one torque transmitting mechanism. The at least one latching valve is operable to maintain the engagement of the at least one torque transmitting mechanism irrespective of the presence of the pressurized fluid. A pressure regulator valve is disposed in fluid communication with the source and having a first position, a second position, and a regulation position. The pressure regulator valve is operable to regulate the pressurized fluid when the pressure regulator valve is in the regulation position. A lubrication circuit is operable to lubricate the automatically shiftable transmission. The pressure regulator valve is operable to selectively and variably communicate the pressurized fluid to the lubrication circuit.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1a is a schematic illustration of a hydraulic circuit of a latched pump applied clutch transmission illustrating a logic valve, in a spring set position, operable to communicate pressurized fluid to a lubrication circuit of the latched pump applied clutch transmission;

FIG. 1b is a schematic illustration of the hydraulic circuit of FIG. 1a illustrating the logic valve, in a pressure set position;

FIG. 2a is a schematic illustration of an alternate embodiment of the hydraulic circuit of FIGS. 1a and 1b illustrating a pressure regulator valve, in a spring set position, operable to selectively and variably communicate pressurized fluid to the lubrication circuit of the latched pump applied clutch transmission;

FIG. 2b is a schematic illustration of the hydraulic circuit of FIG. 2a illustrating the pressure regulator valve, in a pressure set position;

FIG. 2c is a schematic illustration of the hydraulic circuit of FIGS. 2a and 2b illustrating the pressure regulator valve, in a regulation position;

FIG. 3a is a schematic illustration of an alternate embodiment of the hydraulic circuits of FIGS. 1a, 1b, 2a, 2b, and 2c illustrating a logic valve and pressure regulator valve, each in a spring set position, operable to selectively and variably communicate pressurized fluid to the lubrication circuit of the latched pump applied clutch transmission;

FIG. 3b is a schematic illustration of the hydraulic circuit of FIG. 3a illustrating the logic valve, in a pressure set position, and the pressure regulator valve, in a regulation position;

FIG. 4a is a schematic illustration of an alternate embodiment of the hydraulic circuit of FIGS. 1a, 1b, 2a, 2b, 2c, 3a, and 3b illustrating a snap action valve, in a spring set position, operable to selectively and variably communicate pressurized fluid to the lubrication circuit of the latched pump applied clutch transmission; and

FIG. 4b is a schematic illustration of the hydraulic circuit of FIG. 4a illustrating the snap action valve, in a pressure set position.

### DETAILED DESCRIPTION

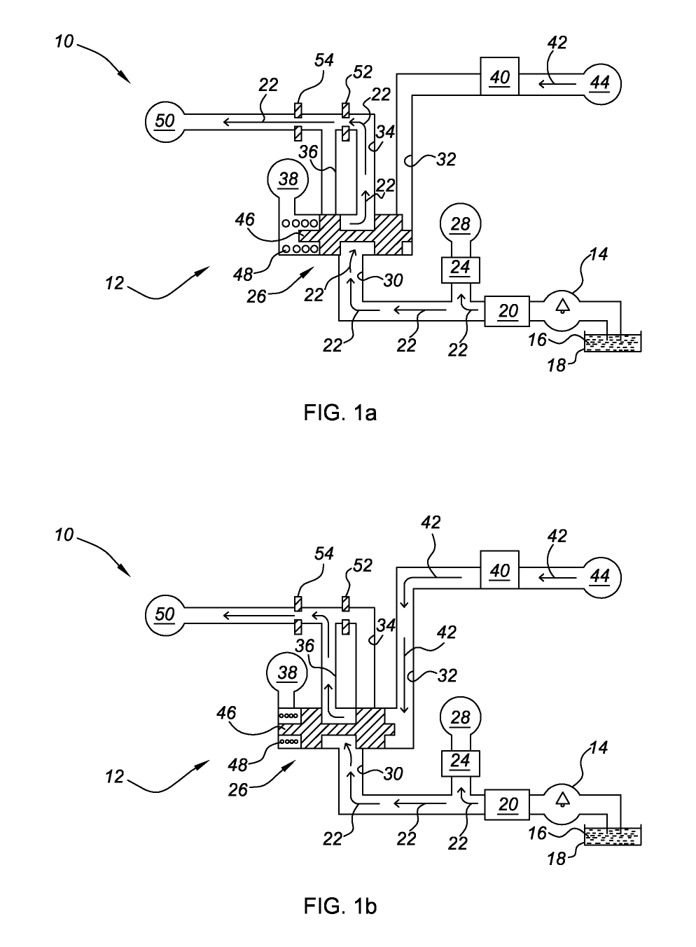

Referring to the drawings wherein like reference numbers correspond to like of similar components throughout the several figures, there is shown in FIG. 1a a portion of a vehicular transmission 10. The transmission 10 includes a hydraulic circuit 12, a portion of which is shown in FIG. 1a. The hydraulic circuit 12 includes a hydraulic pump 14, such as a positive displacement pump, operable to draw fluid 16 from a reservoir 18 and provide pressurized fluid to a main pressure regulator 20. The pressurized fluid, indicated by arrows 22, is communicated from the main pressure regulator 20 to a latching valve 24 and a logic valve assembly 26. The latching valve 24 is operable to selectively communicate pressurized fluid 22 to a hydraulically actuated clutch or torque transmitting mechanism 28 to effect the engagement thereof. Once the torque transmitting mechanism 28 is engaged, the latching valve 24 maintains the engagement of the torque transmitting mechanism 28 irrespective of the presence or magnitude of the pressurized fluid 22. Therefore, the transmission 10 may be characterized as a latched pump applied clutch, or LPAC, transmission. Those skilled in the art will recognize that the transmission 10 may include multiple latching valves 24 and torque transmitting mechanisms 28; however, only one of each is shown in the figures for clarity.

The logic valve assembly 26 is in communication with a passage 30, control passage 32, first lubrication branch 34, second lubrication branch 36, and exhaust port 38. A solenoid valve 40, such as a variable bleed solenoid valve or an on/off solenoid valve, is operable to selectively communicate fluid, indicated by arrows 42, from an actuator feed source 44 to the logic valve assembly 26. The logic valve assembly 26 includes a spool valve 46 biased in a spring set position by a spring 48, as shown in FIG. 1a. A lubrication circuit 50 is provided in communication with the logic valve assembly 26 through both of a first and second orifice 52 and 54, respectively, or only the second orifice 54 depending on the state of operation of the hydraulic control circuit 12. In the preferred embodiment, the first orifice 52 is more restrictive than the second orifice 54.

The latching nature of the latching valve 24 permits the pressure of the pressurized fluid 22, often times referred to as line pressure, to be reduced once the torque transmitting mechanism 28 has engaged thereby increasing the operating efficiency, through a reduction in spin-losses, of the transmission 10. FIG. 1a illustrates the hydraulic circuit 12 when operating with the pressurized fluid 22 at high pressure. In this high line pressure mode of operation, the solenoid valve 40 restricts communication of fluid 42 to the logic valve assembly 26. As such, the spool valve 46 is biased into the spring set position by the spring 48. With the spool valve 46 in the spring set position, the pressurized fluid 22 is allowed to pass from the passage 30 into the first lubrication branch 34. The pressurized fluid 22 is subsequently communicated to the lubrication circuit 50 though the first and second orifices 52 and 54. The pressure drop through the first and second orifices 52 and 54 are preferably tuned for the high pressure conditions such that a sufficient amount of pressurized fluid 22 is communicated to the lubrication circuit 50 to avoid damaging components within the transmission 10.

Referring now to FIG. 1b, there is shown the hydraulic circuit 12 when operating with the pressurized fluid 22 at low pressure. In this low line pressure mode of operation, the solenoid valve 40 communicates fluid 42 from the actuator feed source 44 to the logic valve assembly 26 via the control passage 32. As such, the spool valve 46 is biased into a pressure set position, as shown in FIG. 1b, against the bias force of the spring 48. With the spool valve 46 in the pressure set position, the pressurized fluid 22 is allowed to pass from the passage 30 into the second lubrication branch 36. The pressurized fluid 22 is subsequently communicated to the lubrication circuit 50 though only the second orifice 54. The pressure drop and flow through the second orifice 54 is preferably tuned for the low pressure conditions such that a sufficient amount of pressurized fluid 22 is communicated to the lubrication circuit 50 to avoid damaging the transmission 10. The logic valve assembly 26 therefore provides two discrete flow states relative to the pressure of the pressurized fluid 22 from the main pressure regulator 20.

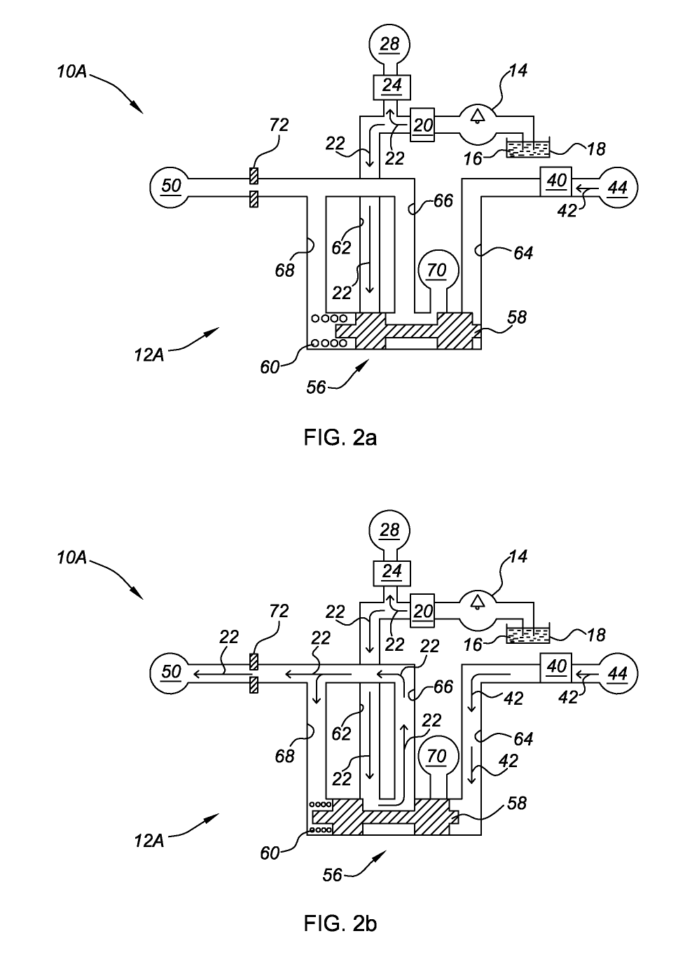

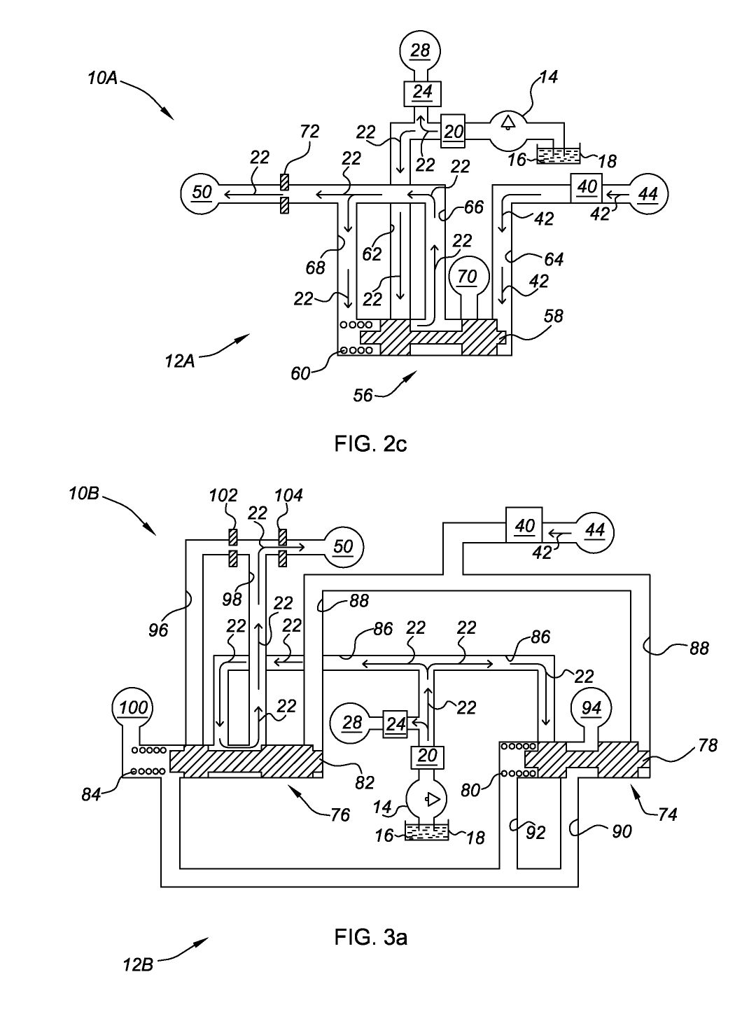

Referring now to FIG. 2a, there is shown an alternate embodiment of the transmission 10 of FIGS. 1a and 1b, generally indicated at 10A. The transmission 10A includes a hydraulic circuit 12A. The hydraulic circuit 12A includes a pressure regulator valve assembly 56. The pressure regulator valve assembly 56 includes a spool valve 58 and a spring 60 operable to bias the spool valve 58 into a spring set position as illustrated in FIG. 2a. The pressure regulator valve assembly 56 is in communication with a passage 62, control passage 64, regulator outlet passage 66, feedback passage 68, and exhaust port 70.

In operation, with the spool valve 58 in the spring set position, the pressurized fluid 22 is substantially blocked or prevented from passing from the passage 62 to the regulator outlet passage 66 by the spool valve 58, thereby eliminating the flow of pressurized fluid 22 to the lubrication circuit 50. Any fluid contained within the lubrication circuit 50 will exhaust through the regulator outlet passage 66 via the exhaust port 70.

Referring to FIG. 2b, the pressure regulator valve assembly 56 is illustrated with the spool valve 58 in a pressure set position. In this condition, the solenoid valve 40, which is preferably a variable bleed solenoid valve, commands an amount of pressure necessary such that fluid 42 will bias the spool valve 58 against the bias force of the spring 60. With the spool valve 58 in the pressure set position, the pressurized fluid 22 may pass, substantially unregulated, from the passage 62 into the regulator outlet passage 66 for subsequent introduction to the lubrication circuit 50. An orifice 72 provides a predictable relationship between pressure and flow of pressurized fluid 22 entering the lubrication circuit 50.

Referring now to FIG. 2c the pressure regulator valve assembly 56 is illustrated with the spool valve 58 in a regulation position. In this condition, the solenoid valve 40, which is preferably a variable bleed solenoid valve, commands a variable amount of pressure such that fluid 42 will bias the spool valve 58 against the bias force of the spring 60 into the regulation position thereby allowing the spool valve 58 to modulate. With the spool valve 58 in the regulation position, the pressurized fluid 22 is regulated as it passes from the passage 62 into the regulator outlet passage 66 for subsequent introduction to the lubrication circuit 50. An amount of the regulated pressurized fluid 22 is communicated to the pressure regulator valve assembly 56 via the feedback passage 68 to provide the spool valve 58 with a feedback signal. The pressure regulator valve assembly 56 is effective in controlling the flow of pressurized fluid 22 to the lubrication circuit 50 over a broad range, i.e. zero to full pressure provided by the main pressure regulator 20 (minus the offset created by the spring rate of the spring 60).

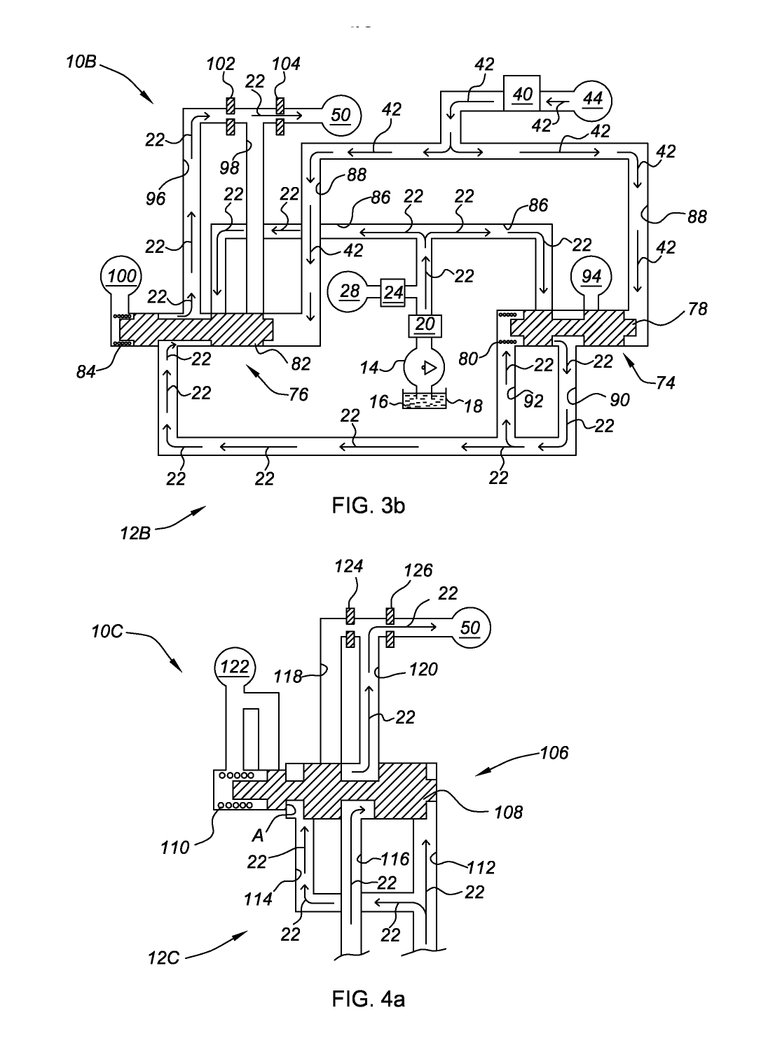

Referring now to FIG. 3a there is shown an alternate embodiment of the transmission 10 of FIGS 1a and 1b and transmission 10A of FIGS. 2a through 2c, generally indicated at 10B. The transmission 10B includes a hydraulic circuit 12B. The hydraulic circuit 12B includes a pressure regulator valve assembly 74 and a logic valve assembly 76. The pressure regulator valve assembly 74 includes a spool valve 78 and a spring 80 operable to bias the spool valve 78 into a spring set position as illustrated in FIG. 3a. Similarly, the logic valve assembly 76 includes a spool valve 82 and a spring 84 operable to bias the spool valve 82 into a spring set position as illustrated in FIG. 3a. The pressure regulator valve assembly 74 is in communication with a passage 86, control passage 88, regulator output passage 90, feedback passage 92, and exhaust port 94. The logic valve assembly 76 is in communication with the passage 86, control passage 88, regulator output passage 90, first lubrication branch 96, second lubrication branch 98, and exhaust port 100. The first lubrication branch 96 is operable to communicate pressurized fluid 22 to the lubrication circuit 50 through a first and second orifice 102 and 104, respectively. The second lubrication branch is operable to communicate pressurized fluid 22 to the lubrication circuit 50 through only the second orifice 104. Preferably the first orifice 102 is more restrictive than the second orifice 104.

FIG. 3a illustrates the hydraulic circuit 12B when operating with the pressurized fluid 22 at low pressure. In this low line pressure mode of operation, the solenoid valve 40, preferably a variable bleed solenoid valve, restricts communication of fluid 42 to the pressure regulator valve assembly 74 and the logic valve assembly 76. As such, the spool valve 78 of the pressure regulator valve assembly 74 is biased into the spring set position by the spring 80; likewise, the spool valve 82 of the logic valve assembly 76 is biased into the spring set position by the spring 84. With the spool valve 82 in the spring set position, the pressurized fluid 22 is allowed to pass from the passage 86 into the second lubrication branch 98. The pressurized fluid 22 is subsequently communicated to the lubrication circuit 50 though the second orifice 104. The flow through the second orifice 104 is preferably tuned for the low pressure conditions such that a sufficient amount of pressurized fluid 22 is communicated to the lubrication circuit 50 to avoid damaging the transmission 10B. With the spool valve 78 in the spring set position, the pressure regulator valve assembly 74 substantially blocks or prevents the communication of pressurized fluid 22 to the logic valve assembly 76 via the regulator outlet passage 90.

Referring now to FIG. 3b, there is shown the hydraulic circuit 12B when operating with the pressurized fluid 22 at high pressure. In this high line pressure mode of operation, the solenoid valve 40 communicates fluid 42 from the actuator feed source 44 to the pressure regulator valve assembly 74 and the logic valve assembly 76 via the control passage 88. As such, the spool valve 78 is biased into a regulation position, as shown in FIG. 3b, against the bias of the spring 80, while the spool valve 82 is biased into a pressure set position against the bias of spring 84. With the spool valve 82 of the logic valve assembly 76 in the pressure set position, the pressurized fluid 22 is blocked or prevented from to passing from the passage 86 into the second lubrication branch 98. Instead pressurized fluid 22 from within the passage 86 is regulated by the pressure regulator valve assembly 74 and subsequently communicated to the logic valve assembly 76 via the regulator outlet passage 90. Those skilled in the art will recognize that the variable bleed nature of the solenoid valve 40 will allow the spool valve 78 to modulate against the bias of spring 80 and the pressurized fluid 22, thereby regulating the pressurized fluid 22 communicated to the regulator outlet passage 90. Pressurized fluid 22 entering the feedback passage 92 provides a feedback signal to the spool valve 78. The pressurized fluid 22 is communicated from the logic valve assembly 76 to the first lubrication branch 96 where the pressurized fluid 22 is subsequently introduced to the lubrication circuit 50 through the first and second orifices 102 and 104. The pressure of the pressurized fluid 22 is therefore controlled or regulated by modulating the spool valve 78 of the pressure regulator valve assembly 74, while the flow of pressurized fluid 22 to the lubrication circuit 50 is controlled by the first and second orifices 102 and 104, respectively.

The combination of the pressure regulator valve assembly 74 and the logic valve assembly 76 allows precise regulation of the pressure of the pressurized fluid 22, while also permitting the pressure of the pressurized fluid 22 to drop to a value substantially equal to the pressurized fluid exiting the main pressure regulator valve 20. Since latched pump applied clutch transmission, such as transmission 10B are able to operate at relatively low line pressure values, the combination of the pressure regulator valve assembly 74 and the logic valve assembly 76 allows the hydraulic circuit 12B to operate at the minimum line pressure required to maintain adequate flow of pressurized fluid 22 to the lubrication circuit 50 to avoid damaging components within the transmission 10B.

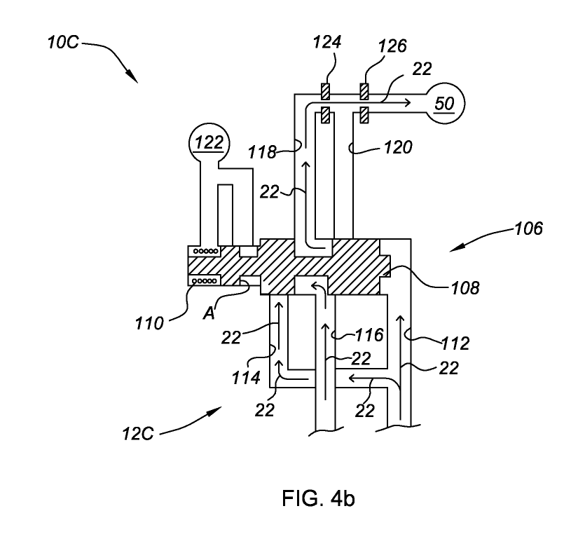

Referring now to FIG. 4a there is shown an alternate embodiment of the transmission 10 of FIGS. 1a and 1b, transmission 10A of FIGS. 2a through 2c, and transmission 10B of FIGS. 3a and 3b, generally indicated at 10C. The transmission 10C includes a hydraulic circuit 12C. The hydraulic circuit 12C includes a snap action valve assembly 106. The snap action valve assembly 106 includes a spool valve 108 and a spring 110 operable to bias the spool valve 108 into a spring set position as illustrated in FIG. 4a. A differential area, denoted by the letter A, is defined on the spool valve 108. The snap action valve assembly 106 is in communication with a passage 112, passage 114, passage 116, first lubrication branch 118, second lubrication branch 120, and exhaust port 122. The first lubrication branch 120 is operable to communicate pressurized fluid 22 to the lubrication circuit 50 through a first and second orifice 124 and 126, respectively. The second lubrication branch 120 is operable to communicate pressurized fluid 22 to the lubrication circuit 50 through only the second orifice 126. Preferably the first orifice 124 is more restrictive than the second orifice 126.

FIG. 4a illustrates the hydraulic circuit 12C when operating with the pressurized fluid 22 at low pressure. In this low line pressure mode of operation, the pressure of the pressurized fluid 22 operating on the differential area A from passage 114 is insufficient to shuttle or move the spool valve 108 from a spring set position, shown in FIG. 4a, to a pressure set position, shown in FIG. 4b. As such, the spool valve 108 remains in the spring set position and allows the communication of pressurized fluid within the passage 116 to the second lubrication branch 120 where it is subsequently introduced to the lubrication circuit through the second orifice 126. Preferably, the second orifice 126 is sized to allow adequate flow of pressurized fluid 22 to the lubrication circuit 50 at low line pressure modes of operation.

FIG. 4b illustrates the hydraulic circuit 12C when operating with the pressurized fluid 22 at high pressure. In this high line pressure mode of operation, the pressure of the pressurized fluid 22 operating on the differential area A from passage 114 is sufficient to shuttle or move the spool valve 108 from the spring set position to the pressure set position as shown in FIG. 4b. Once the spool valve 108 is in the pressure set position, the pressurized fluid 22 acting on the differential area A is exhausted through the exhaust port 122. Therefore, the pressurized fluid 22 within passage 112 retains the spool valve 108 in the pressure set position. The pressurized fluid 22 within passage 116 is communicated to the first lubrication branch 118, via the snap action valve assembly 106, where the pressurized fluid 22 is subsequently introduced to the lubrication circuit 50 through the first and second orifices 124 and 126. The pressure drop and flow restriction through the first and second orifices 124 and 126 are preferably tuned for the high line pressure conditions such that a sufficient amount of pressurized fluid 22 is communicated to the lubrication circuit 50 to avoid damaging components within the transmission 10C.

As described hereinabove with reference to FIGS. 4a and 4b, the snap action valve 106 may be used to provide two distinct flow characteristics to the lubrication circuit 50. The area of the differential area A and the spring rate of the spring 110 should be chosen for the line pressure at which the spool valve 108 will shuttle or move from the spring set position to the pressure set position. The snap action valve assembly 106 is a low cost option for controlling the flow of pressurized fluid 22 to the lubrication circuit 50 since the solenoid valve 40 of FIGS. 1a, 1b, 2a, 2b, 2c, 3a, and 3b is not required to effect movement of the spool valve 108.

While the best modes for carrying out the invention have been described in detail, those familiar with the art to which this invention relates will recognize various alternative designs and embodiments for practicing the invention within the scope of the appended claims. A damping orifice is preferably used with any valve described within the present disclosure.

1. A transmission comprising:
a source of pressurized fluid;
a valve in fluid communication with said source and having a first position and a second position;
a lubrication circuit operable to lubricate the transmission;
wherein said valve is operable to communicate said pressurized fluid to said lubrication circuit;
first and second orifices disposed between said valve and said lubrication circuit;
wherein said valve is configured to supply said lubrication circuit with said pressurized fluid through each of said first and said second orifices when said valve is in one of said first position and said second position;
wherein said valve is configured to supply said lubrication circuit with said pressurized fluid through said second orifice when said valve is in the other of said first position and said second position; and
wherein said valve is a snap action valve and wherein said snap action valve includes a differential area in fluid communication with said source and operable to move said valve from said first position to said second position when the pressure of said pressurized fluid is greater than or equal to a predetermined value.

2. The transmission of claim 1, further comprising:
at least one selectively engageable torque transmitting mechanism;
at least one latching valve in communication with said source and operable to selectively communicate said pressurized fluid to effect engagement of said at least one torque transmitting mechanism; and
wherein said at least one latching valve is operable to maintain engagement of said at least one torque transmitting mechanism irrespective of the presence of said pressurized fluid.

3. The transmission of claim 1, wherein said first orifice is more restrictive than said second orifice.

4. The transmission of claim 1, further comprising:
one of a variable bleed solenoid valve and an on/off solenoid valve;
wherein said valve is a logic valve; and
wherein said one of said variable bleed solenoid valve and said on/off solenoid valve is configured to selectively place said logic valve in said first and said second positions.

5. The transmission of claim 1, further comprising:
a pressure regulator valve operable to regulate said fluid pressure and selectively communicate said regulated fluid pressure to said valve; and
wherein said regulated fluid pressure is communicated to said lubrication circuit through said first and second orifices when said valve is in said second position.

6. The transmission of claim 5, further comprising a variable bleed solenoid valve operable to selectively control said valve and said pressure regulator valve.

7. The transmission of claim 5, wherein said valve is a logic valve.

8. A transmission comprising:
a source of pressurized fluid;
at least one selectively engageable torque transmitting mechanism;
at least one latching valve in communication with said source, the latching valve having a first position and a second position and being operable to selectively communicate said pressurized fluid to effect engagement of said at least one torque transmitting mechanism;
wherein said at least one latching valve is operable to maintain engagement of said at least one torque transmitting mechanism irrespective of the presence of said pressurized fluid;
a pressure regulator valve in fluid communication with said source and having a first position, a second position, and a regulation position;
wherein said pressure regulator valve is operable to regulate said pressurized fluid when said pressure regulator valve is in said regulation position;
a lubrication circuit operable to lubricate the transmission;
wherein said pressure regulator valve is operable to selectively and variably communicate said pressurized fluid to said lubrication circuit; and
wherein said latching valve is a snap action valve and wherein said snap action valve includes a differential area in fluid communication with said source and operable to move said valve from said first position to said second position when the pressure of said pressurized fluid is greater than or equal to a predetermined value.

9. The transmission of claim 8, further comprising an orifice disposed between said pressure regulator valve and said lubrication circuit and operable to restrict the flow of said pressurized fluid from said pressure regulator valve to said lubrication circuit.

10. The transmission of claim 8, further comprising:
a variable bleed solenoid valve; and
wherein said variable bleed solenoid valve is operable to selectively place said pressure regulator valve in said first, second, and regulation position.

11. The transmission of claim 8, further comprising:
a logic valve disposed between said pressure regulator valve and said lubrication circuit and in communication with said source;
wherein said logic valve has a first position and a second position;
wherein said logic valve is operable to substantially restrict the communication of said regulated fluid from said pressure regulator valve to said lubrication circuit when said logic valve is in said first position; and
wherein said logic valve is operable to communicate said regulated fluid from said pressure regulator valve to said lubrication circuit when said logic valve is in said second position.

12. The transmission of claim 11, wherein said logic valve is operable to communicate said pressurized fluid from said source to said lubrication circuit when said logic valve is in said first position.

13. The transmission of claim 11, further comprising:
first and second orifices disposed between said logic valve and said lubrication circuit;
wherein said logic valve is configured to supply said lubrication circuit with said regulated fluid from said pressure regulator valve through each of said first and said second orifices when said logic valve is in said second position; and
wherein said logic valve is configured to supply said lubrication circuit with said pressurized fluid from said source through said second orifice when said logic valve is in said first position.

14. The transmission of claim 11, further comprising:
a variable bleed solenoid valve;
wherein said variable bleed solenoid valve is operable to selectively place said pressure regulator valve in said first, second, and regulation position and said logic valve in said first and second position.

15. A hydraulic control circuit for a transmission comprising:
a source of pressurized fluid;
at least one selectively engageable torque transmitting mechanism;
at least one latching valve in communication with said source, the latching valve having a first position and a second position and being operable to selectively communicate said pressurized fluid to effect engagement of said at least one torque transmitting mechanism;
wherein said at least one latching valve is operable to maintain engagement of said at least one torque transmitting mechanism irrespective of the presence of said pressurized fluid communicated to said latching valve;
a valve in fluid communication with said source;
a lubrication circuit operable to lubricate the transmission;
wherein said valve is operable to variably communicate said pressurized fluid to said lubrication circuit; and
wherein said latching valve is a snap action valve and wherein said snap action valve includes a differential area in fluid communication with said source and operable to move said valve from said first position to said second position when the pressure of said pressurized fluid is greater than or equal to a predetermined value.

16. The hydraulic control circuit of claim 15, further comprising:
a logic valve;
first and second orifices disposed between said logic valve and said lubrication circuit;
wherein said logic valve is configured to supply said lubrication circuit with said pressurized fluid through each of said first and said second orifices when said logic valve is in one of said first position and said second position;
wherein said logic valve is configured to supply said lubrication circuit with said pressurized fluid through said second orifice when said logic valve is in the other of said first position and said second position; and
wherein said first orifice is more restrictive than said second orifice.

17. The hydraulic control circuit of claim 16, further comprising:
a pressure regulator valve operable to regulate said fluid pressure and selectively communicate said regulated fluid pressure to said valve; and
wherein said regulated fluid pressure is communicated to said lubrication circuit through said first and second orifices when said valve is in said second position.

18. The hydraulic control circuit of claim 15, wherein said valve is a pressure regulator valve and wherein said pressure regulator valve is in fluid communication with said source and has a first position, a second position, and a regulation position;
wherein said pressure regulator valve is operable to regulate said pressurized fluid when said pressure regulator valve is in said regulation position; and
wherein said pressure regulator valve is operable to communicate said regulated fluid to said lubrication circuit.
